(19) United States
(12) Patent Application Publication
(10) Pub. No.: US 2011/0113591 A1
(43) Pub. Date: May 19, 2011

(54) CLEANING IMPLEMENT HAVING AUDIBLE CONSUMER SIGNAL

(76) Inventors: William Paul Mahoney, III, Liberty Township, OH (US); Paul John Edward Vernon, Hamilton, OH (US)

(21) Appl. No.: 12/621,840

(22) Filed: Nov. 19, 2009

(51) Int. Cl. A47L 9/22; H02P 7/00

(52) U.S. Cl. 15/412; 318/139; 318/445

(57) ABSTRACT

A battery-powered cleaning implement for cleaning a target surface by using at least one of a motor-driven beater bar or motor-driven vacuum fan. The cleaning implement has a cutoff voltage below which the beater bar and/or said fan is/are no longer operable to clean. The cleaning implement has a control which reduces voltage provided by the battery/ies to the motor before the cutoff voltage is reached. The reduction in voltage provided to the beater bar and/or fan vacuum reduces the rotational velocity, providing an audible signal to a user that said voltage provided to said motor is being depleted.

### FIELD OF THE INVENTION

The present invention relates to cleaning implements and more particularly to battery powered cleaning implements.

### BACKGROUND OF THE INVENTION

Cleaning implements are in daily use. Such implements are used to remove debris from surfaces, such as floors. The implement may clean the floor using a motor-driven beater bar, motor-driven fan vacuum, or both. The implement may have rechargeable battery power for convenience. One successful execution of this type of implement is found in the Swiffer SweeperVac® sold by the instant assignee.

However, such implements are not without problems. If the battery begins to run down, cleaning performance is comprised. Then the implement may not remove all debris from the target surface. Even worse, the implement may completely shut down. Then the user may then be left with rooms only partially cleaned until the battery(ies) is/are recharged and the process starts over.

Attempts have been made in the art to accommodate end of battery life problems. For example, the implement could carry a spare battery pack. But this approach increases the cost and weight of the implement.

Yet another approach is to provide a visual indicator, such as an LED as the end of usable battery life is approached. However, the visual indicator may not be easy to see, or the user may not notice the visual indicator during the cleaning process and while looking at the floor. Even if the user does notice the LED, he/she may not understand how much cleaning can occur, until the end of usable battery life occurs.

Yet another approach is to limit the connection time of the battery to the load, particularly a motor. This approach requires reducing power to the motor load continually or in multiple steps so that rotational frequency of the motor is reduced. However, the predicted connection time may not take into account increased battery life which occurs as rotational frequency of the motor is reduced or take into account a threshold frequency at which the efficacy of the implement is compromised—even though the motor is still running. For example, a motor driven fan which provides vacuum to a cleaning implement may rotate, but provide no suction for removing debris. This approach may lead to user frustration when the user attempts to clean with an implement that is apparently working, but not working at a performance level sufficient to provide cleaning. See U.S. Pat. Nos. 5,623,193; 5,694,020 and 6,188,142. Accordingly, there is a need in the art to improve rechargeable battery powered cleaning implements.

### SUMMARY OF THE INVENTION

In one embodiment the invention comprises a control circuit for a battery-powered cleaning implement, said control circuit comprising means for reducing voltage supplied from a battery to a motor, wherein the motor operably drives a load comprising a fan, a beater bar or both, said control circuit have a predetermined cutoff voltage, whereby said circuit reduces the voltage supplied to the motor during use prior to the battery voltage becoming inoperable to drive said load, said reduced voltage as supplied to the motor providing an audible signal to a user of the respective cleaning implement that the battery voltage is being depleted.

### BRIEF DESCRIPTION OF THE DRAWINGS

FIGS. 1A-1B are elevational views of a cleaning implement according to the present invention.

FIG. 2 is a circuit diagram of an exemplary circuit for reducing power to a motor in the implement.

FIG. 3 is an exemplary performance chart showing the change in voltage and amperage supplied to the motor as battery life is depleted.

### DETAILED DESCRIPTION OF THE INVENTION

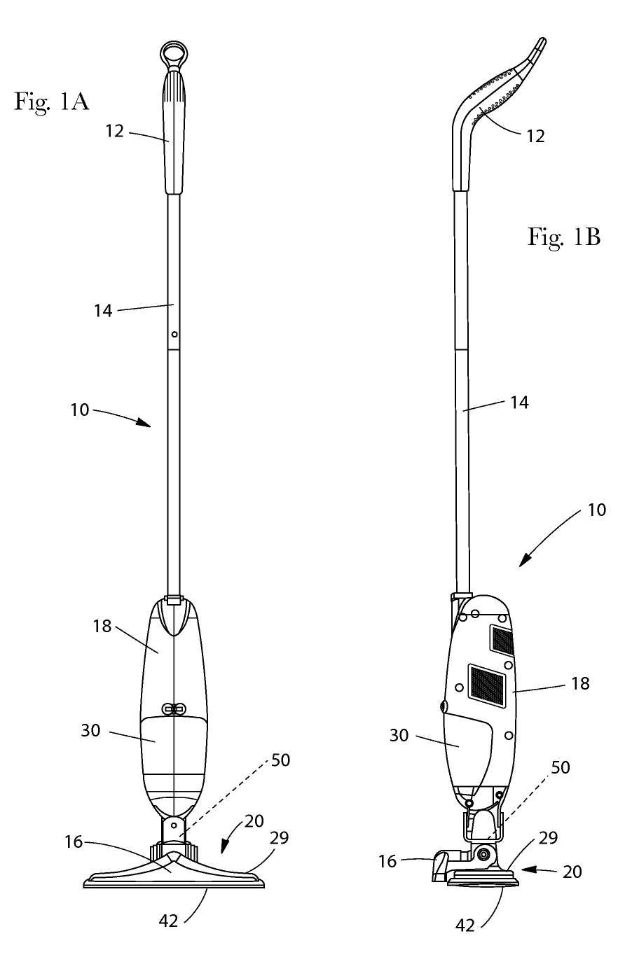

Referring to FIGS. 1A and 1B, the cleaning implement 10 according to the present invention may comprise a head 20, a handle 12 and a pole 14 therebetween. The implement 10 may further comprise a body 18 mounted on the pole 14 as shown, or the components of the body 18 may be integrated into the head 20.

The head 20 may comprise attachments 29 for removably receiving a cleaning sheet 42, a removable dirt bin 30, a suction nozzle 16 and other components as may be helpful. The body 18 may comprise a fan, a motor therefor, batteries to power the motor and optionally an inlet for the power cord if line current is utilized, an exhaust for the air flow, and other components as may be helpful. There is also provision for communication of air flow between the head 20 and body 18. The dirt bin 30 may be mounted on the body 18. See U.S. Pat. No. 7,137,169.

The handle 12 may provide for ergonomic manipulation of the implement 10. An on-off switch may be disposed on the handle 12, body 18, head 20 or pole 14. While an implement 10 suitable for a standing user is illustrated, the invention is not so limited. The pole 14 may be shortened or eliminated and the handle 12 configured for hand-held ergonomics or for use on one's hands and knees.

As used herein horizontal refers to the primary direction of the movement of the head 20 of the implement 10 along a horizontal target surface and which occurs within the plane of the target surface. Vertical refers to the direction perpendicular to the target surface and horizontal direction, and which spaces apart the top surface and bottom surface. The width of the implement 10 refers to the left-right direction as it is in use. The front-back direction is perpendicular thereto and parallel to the target surface.

Examining the components in more detail, the head 20 may comprise a top or generally upwardly facing surface and a bottom surface opposed thereto. The head 20 and particularly the bottom surface thereof, moves relative to the target surface to be cleaned.

The target surface may be a floor, and more particularly a hard surface floor, such as tile, hardwood, linoleum, etc. A cleaning sheet 42 may be attached to the bottom surface, using attachments 29 as are known in the art.

The implement 10 may be provided with one or more beater bars, as is known in the art and illustrated by U.S. Pat. No. 7,013,528. The motor may be utilized to provide power to the beater bars instead of, or in addition to, the fan.

Exemplary attachments 29 include deformable grippers, etc. Deformable grippers may be used to attach the cleaning sheet 42, because such an attachment works with a variety of sheet 42 materials, does not require extra manufacturing steps in the sheet 42 (such as the addition of adhesive) and may last for the life of the implement 10.

The suction nozzle 16 may be pivotably attached to the head 20, as illustrated by U.S. Pat. No. 7,293,322 B2 or 2004/0045126 A1. Alternatively, the suction nozzle 16 may be held stationary relative to the balance of the head 20.

Provision for communication of air flow between the head 20 and body 18 may comprise a rigid or flexible hose or tubing, referred to hereinafter as a hose 50. The hose 50 may have a proximal end 51 permanently or removably attached to the head 20 and a distal end permanently or removably attached to the body 18. Air flow may begin in and/or exhaust from the body 18, as initiated by a powered fan, as is well known in the art.

Air flow from the fan may enter the head 20 through bottom surface of the head 20 or though such other position where the suction nozzle 16 may be disposed. Air flow may exit the head 20 and enter the hose 50 through an opening in the top surface of the head 20. The fan may be powered by a direct current motor. The DC motor may have a power rating of about 30 to about 40 Watts.

If the hose 50 is removably attached at the proximal end 51 to the head 20, the proximal end 51 of the hose 50 may have a geometry which corresponds with the geometry of the opening in the top surface of the head 20. An air filter may be inserted over the opening and clamped in place using the proximal end of the hose 50.

The body 18 may be mounted on, and optionally removable from, the pole 14. The body 18 may also carry and/or enclose the fan, a motor therefor, batteries, etc. The body 18, and balance of the cleaning implement 10, may generally be constructed in accordance with the teachings of US 2007/0062000 A1, published Mar. 22, 2007.

The motor may be powered by rechargeable batteries, as is known in the art or by batteries which are discarded upon first depletion. Suitable batteries include NiCad batteries and NickelMetalHydride batteries as are known in the art.

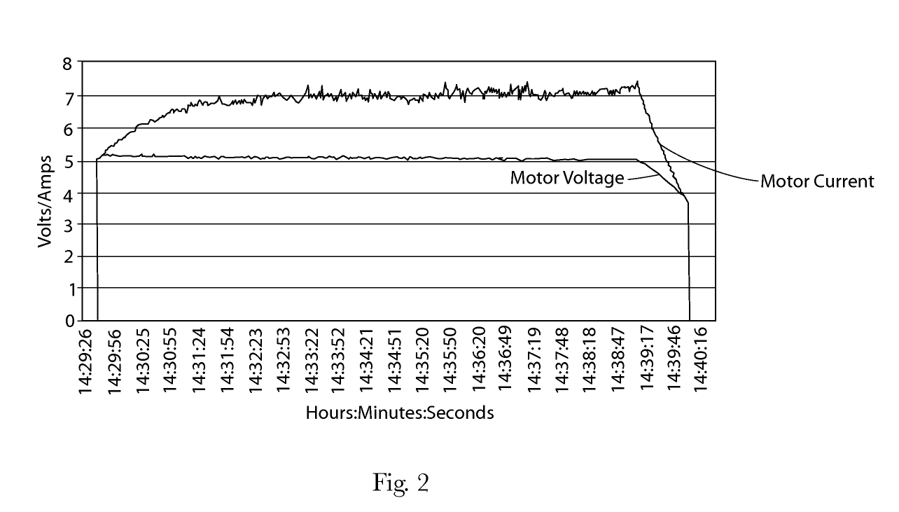

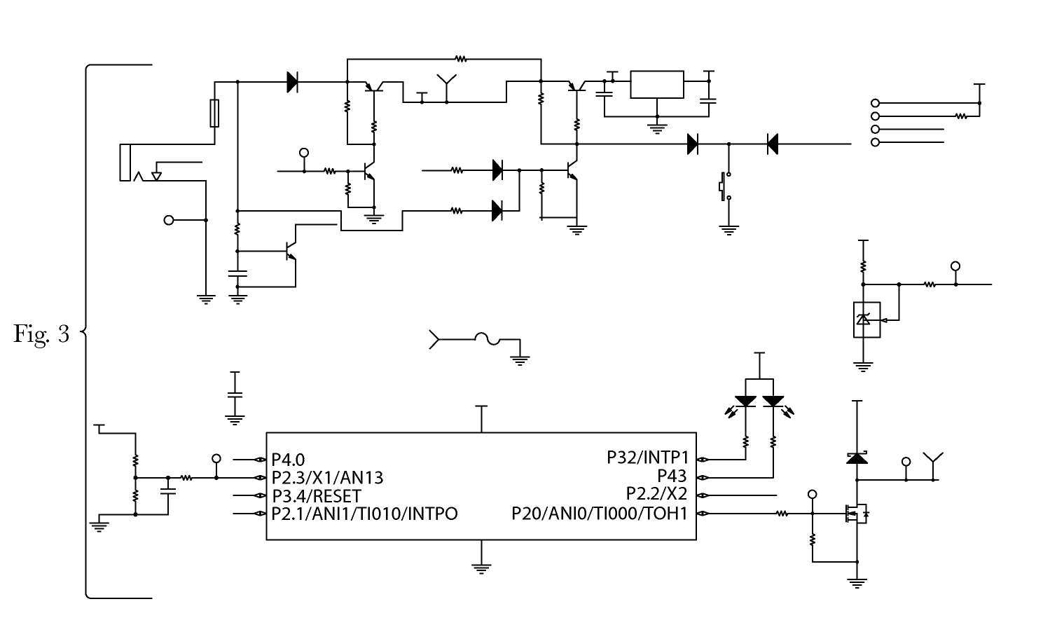

Referring to FIGS. 2-3, the implement 10 may further comprise a control circuit. The control circuit is operably connected to the battery pack and to the fan motor. The control circuit reduces the rotational velocity of the fan motor as the battery voltage decreases to less than a threshold voltage. The control circuit may be controlled by microprocessor.

The batteries may have an initial voltage of about 9±0.5 volts. The initial voltage may reduce to a cutoff voltage of about 4.8±0.2 volts during use. Such reduction in voltage may yield a corresponding voltage supplied to the motor of about 5.3 to about 3.5 volts, respectively.

Thus, a reduction in rotational velocity of the motor(s) which power(s) the fan, beater bar or both may be achieved by providing a concomitant reduction in the voltage supplied to the motor. The reduction in voltage supplied to the motor may be accomplished using pulse width modulation, amplitude modulation, frequency modulation, etc. as are known in the art. An exemplary circuit for providing pulse width modulation is illustrated, although one of skill will recognize the invention is not so limited.

The threshold voltage which activates the pulse with modulation may be determined using a voltage discriminator. The voltage discriminator activates the circuit which reduces the pulse duty cycle. As the pulse duty cycle is reduced, the rotational velocity of the motor decreases.

The reduction in rotational velocity may occur according to a predetermined algorithm, or according to a variable scheme, between charges of the battery. The reduction in rotational velocity may occur monotonically, to provide an audible signal to the user that the end of that battery charge is being approached. The user may then take appropriate action to finish or abort to the cleaning task. By providing the audible signal, the user is able to concentrate on the cleaning task, without having to look for a visual signal on the implement 10.

With continuing reference to FIG. 3, a suitable rundown period of time has been found to range from about 30 to about 60 seconds. If the rundown period occurs too slowly, the user may not perceive the rundown is occurring. Furthermore, the user is likely to attempt cleaning with an implement 10 performing with reduced efficacy for a greater period of time. If the rundown period occurs too quickly, the user will not have enough time to find a convenient point at which to end the cleaning task.

The dimensions and other values disclosed herein are not to be understood as being strictly limited to the exact numerical values recited. Instead, unless otherwise specified, each such value is intended to mean both the recited value and a functionally equivalent range surrounding that value. For example, a dimension disclosed as “40 mm” is intended to mean “about 40 mm.”

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A control circuit for a battery-powered cleaning implement, said control circuit comprising means for reducing voltage supplied from a battery to a motor, wherein the motor operably drives a load comprising a fan, a beater bar or both, said control circuit have a predetermined cutoff voltage, whereby said circuit reduces the voltage supplied to the motor during use prior to the battery voltage becoming inoperable to drive said load, said reduced voltage as supplied to the motor providing an audible signal to a user of the respective cleaning implement that the battery voltage is being depleted.

2. A circuit according to claim 1 wherein said reduction in said voltage provided to said motor by said control circuit is a monotonic reduction.

3. A circuit according to claim 2 wherein said monotonic reduction in said voltage varies according to a second order curve.

4. A battery-powered cleaning implement for cleaning a target surface by using at least one of a motor-driven beater bar or motor-driven fan vacuum, said cleaning implement having a cutoff voltage below which said beater bar and/or said fan vacuum is no longer operable to clean debris from said target surface, and a means for reducing voltage provided by one or more batteries to the motor before said batteries are depleted to said cutoff voltage, whereby said reduction in said voltage provided to said beater bar and/or said fan vacuum reduces the rotational velocity thereof, thereby providing an audible signal to a user that said voltage provided to said motor is being depleted.

5. An implement according to claim 4 wherein said implement has a vacuum fan, and does not have a beater bar.

6. An implement according to claim 4 wherein said implement further comprises a an attachment for removably attaching a disposable cleaning sheet thereto.
